(19) United States
(12) Patent Application Publication
(10) Pub. No.: US 2015/0237823 A1
(43) Pub. Date: Aug. 27, 2015

(54) STALL FLOOR COVERING MADE OF EXPANDED THERMOPLASTIC POLYURETHANE PARTICLE FORM

(71) Applicant: BASF SE, Ludwigshafen (DE)

(72) Inventors: Wilfried Schmitt, Maxdorf (DE); Uwe Keppeler, Hochdorf-Assenheim (DE)

(73) Assignee: BASF SE, Ludwigshafen (DE)

(21) Appl. No.: 14/432,531

(22) PCT Filed: Sep. 23, 2013
(86) PCT No.: PCT/EP2013/069656

§ 371 Date: Mar. 31, 2015

(30) Foreign Application Priority Data
Oct. 2, 2012 (EP) 12186917.6

(51) Int. Cl. A01K 1/015; B29C 35/04; A01K 29/00

(52) U.S. Cl. CPC A01K 1/0157; A01K 1/015; A01K 29/00; B29C 35/04; B29K 2075/00

(57) ABSTRACT

The invention relates to a stall floorcovering comprising a foam mat comprising expanded thermoplastic polyurethane-bead foam, to processes for producing same, and also to the use of expanded thermoplastic polyurethane-bead foam for producing the stall floorcovering.

The invention relates to a stall floorcovering, comprising a foam mat comprising expanded thermoplastic polyurethane-bead foam, to processes for producing same, and also to the use of expanded thermoplastic polyurethane-bead foam for producing the stall floorcovering. (For the purposes of this application the abbreviation “TPUs” is also used for thermoplastic polyurethanes and the abbreviation “E-TPUs” is also used for expanded thermoplastic polyurethanes).

For the purposes of the present invention, the expression “stall floorcovering” comprises not only floorcoverings in the sector represented by the actual stalls, i.e. the actual housings which provide long-term accommodation for animals, but also coverings for any of the floors on which animals are present for short or long periods, including by way of example floorcoverings in the sector represented by cubicles, cubicle-access passageways, other passageways, and walkers for animals.

The requirements placed upon stall floorcoverings can differ greatly, depending on species of animal and usage sector: the requirements relating to the keeping of livestock (e.g. dairy cattle or pigs) differ by way of example from those relating to the keeping of horses or of dogs. There are also differences between the respective requirements placed upon floorcoverings for the stalls, the cubicle, the cubicle-access passageway, the walkers, the external areas, etc. Nevertheless, there are requirements relating to certain properties that are relevant for all stall floorcoverings and for all species of animal.

By way of example, stall floorcoverings for dairy cattle (known as cattle mattresses) have the aim of improving the wellbeing of the cattle and thus increasing milk yield. Requirements are therefore not only good thermal insulation properties but also high slip resistance and high mechanical strength. There should also be an appropriate level of softness. In principle, maximum softness would be desirable; however, increasing softness is generally accompanied by an indentation depth increase, which must not become so great that it causes severe compression of the stall floorcovering to the extent that it suffers excessive loss of damping properties and reduces the comfort level of animals thereon. Another requirement is retention of a high level of elastomeric properties during long-term use (low compression set). For reasons relating to hygiene, moisture absorption by the cattle mattress should be minimized. The cattle mattress should moreover have chemical resistance to urine, dung, and lactic acid.

Cow mattresses should moreover be dimensionally stable and have low weight, in order to minimize the technical resources required to lay same. Another aspect that has to be considered is cost-effectiveness.

There are therefore various known plastics materials and designs for producing stall floorcoverings that, as far as possible, meet requirements of this type:

By way of example, stall floorcoverings made of solid rubber mats or made of granulated rubber processed with binder to give mats have high mechanical strength values and low moisture absorption values, but are not entirely satisfactory in relation to thermal insulation values and deformability (softness).

In contrast, stall floorcoverings made of foams, for example bonded polyurethane flake foams or latex foams, exhibit substantially better thermal insulation and deformability (softness), but are generally disadvantageous in respect of their mechanical strength and moisture absorption, because of their open-cell foam structure. These disadvantages can be eliminated to a certain extent by using a foil as packaging for the foam mats, and providing the mats with a mechanically stable outer layer that is impermeable to liquid (sandwich structure). However, production processes of greater complexity are needed for this, and make the corresponding stall floorcoverings more expensive. Furthermore, damage can occur to the foils during use or during cleaning, e.g. by a high-pressure cleaner.

EP 1 917 852 A1 describes a floorcovering for animal stalls which has to comprise at least two layers S1 and S2, and also a means of edge sealing, where S1 can be either a fiber material or preferably a foam, and S2 comprises a thermoplastic polymer P2. Suitable polymers mentioned for forming the foam layer S1 are a very wide variety of plastics, preference being given to PVC foams, PE foams, PP foams, and PE copolymer foams; explicit mention is made of a PE foam Trocellen® classic C-MN3 from Trocellen GmbH and of a polyurethane ether foam from Otto Bock Schaumstoffwerke GmbH—but no more detailed characterization of any kind is provided for these. A number of polymers are described as preferred material P2 for forming the outer layer S2; the thermoplastic polyurethane is mentioned merely as one of many possible and non-preferred materials P2.

Although floorcoverings for animal stalls according to EP 1 917 852 A1 have adequate softness, they require improvement as underlay for heavy animals such as cattle because they have comparatively large indentation depth, and also in respect of residual deformation and of wear/abrasion during long-term use, in particular after damage to the outer layer S2.

There are, of course, also floorcoverings described in the prior art which were developed for other applications, examples being sports floors. However, the associated technical teaching cannot necessarily be applied to stall floorcoverings. Although, therefore, some properties are desirable for every type of floorcovering, e.g. good wear resistance during long-term use, the technical solution for achieving said property for one application is not necessarily also suitable for a different application (e.g. because the mechanical loading to which a sports floor is subjected by a sportsperson weighing 75 kg differs from that to which a stall floor is subjected by an ungulate weighing 750 kg). Some of the abovementioned requirements placed on stall floorcoverings are completely irrelevant to other floorcoverings; (by way of example, urine resistance is not generally a criterion for a sports floor).

Although floorcoverings made of polyethylene foams, for example those described in DE 43 42 200 A as gymnastics mats, have good deformability and practically zero moisture absorption, they exhibit high residual deformation after long-term underfoot loading, and they are therefore not very suitable as stall floorcoverings.

US 2010/0047550 A1 discloses hybrid materials inter alia for use in shoe soles, in furniture cushioning, and in floorcoverings for play areas, running tracks, and outdoor and indoor sports facilities. The hybrid materials comprise expanded TPU beads in a matrix made of polyurethane. The polyurethane matrix here can be composed of a compact material, for example of a viscoelastic gel or of a TPU, or else of a foamed material, for example a flexible foam, a semirigid foam, or an integral foam. The good binding of the matrix to the expanded TPU beads is emphasized, as are good mechanical and resilience properties. However, these hybrid materials are not necessarily useful as stall floorcovering, since further improvements are required to wear resistance during long periods of use under demanding conditions, and also to water-permeability, which according to US 2010/0047550 A1 is amenable to wide adjustment.

It was therefore an object of the present invention to provide a lightweight stall floorcovering which is easy to lay and which does not have the disadvantages mentioned of the floorcoverings described in the prior art, and which in particular exhibits an improved combination of appropriate softness (corresponding to a substantial, but not excessive, indentation depth), low residual deformation during long-term use, low wear/abrasion during long-term use, and low moisture absorption values. The stall floorcovering is moreover intended to be obtainable via production processes which are simple and therefore not expensive.

A stall floorcovering comprising a foam mat comprising expanded thermoplastic polyurethane-bead foam has accordingly been found.

The stall floorcovering of the invention can be produced simply and inexpensively, is lightweight and easy to lay, and in comparison with known stall floorcoverings exhibits an improved combination of appropriate softness (corresponding to substantial, but not excessive, indentation depth), low residual deformation during long-term use, low wear/abrasion during long-term use, and low moisture absorption. The foam morphology of the stall floorcovering of the invention leads to low density of the molding and to a high level of thermal insulation. The stall floorcovering of the invention moreover has long-term resistance to animal excrement.

The stall floorcoverings of the invention, the processes for producing same, and the use of expanded thermoplastic polyurethane-bead foam for producing said stall floorcoverings are described in more detail below.

In principle, all of the TPUs known to the person skilled in the art and described in the literature are suitable for producing the stall floorcoverings of the invention comprising a foam mat made of E-TPU-bead foam.

Suitable TPUs and foamed E-TPU beads based on TPU, and also production of these, are disclosed by way of example in WO 94/20568 and WO 07/82838.

The Shore hardness of TPUs that can be used with preference is in the range from 50 Shore A to 75 Shore D, preferably 60 Shore A to 100 Shore A, particularly preferably 65 Shore A to 85 Shore A, measured in accordance with DIN ISO 7619-1 DE on test specimens made of non-expanded thermoplastic polyurethane of thickness 6 mm.

Preferred TPUs that can be used are in particular those in which the melting range begins below 130° C., particularly preferably below 120° C., measured by DSC with a heating rate of 20 K/min, and in which the melt flow rate (MFR) of the thermoplastic polyurethane at 190° C. and with an applied weight of 21.6 kg in accordance with DIN EN ISO 1133 is at most 250 g/10 min preference being given to a melt flow rate smaller than 200 g/10 min, and particular preference being given to a melt flow rate smaller than 150 g/10 min.

Thermoplastic polyurethanes and processes for producing same are well known, and are described in the literature, for example in the abovementioned specifications.

From the TPUs it is possible to produce expanded, i.e. foamed, TPU beads, in particular via the suspension or extrusion processes known to the person skilled in the art and described in the literature. In these processes the foamed E-TPU beads can be obtained directly or indirectly, i.e. by way of unfoamed expandable TPU beads comprising blowing agent as intermediate; (for the purposes of the present invention the expressions “expanded TPU beads” and “expanded TPU-foam beads” are used synonymously and describe individual foamed TPU beads).

In the suspension process, the TPU in the form of granulated material is heated with water, a suspending agent, and a blowing agent in a closed reactor, to above the softening temperature of the granulated material. The polymer beads here become impregnated with the blowing agent. One possibility then is to cool the hot suspension, whereupon the beads harden with inclusion of the blowing agent, and depressurize the reactor. The resultant expandable beads comprising blowing agent are foamed in a subsequent step via heating to give the expanded beads. In an alternative, the hot suspension can be depressurized suddenly without cooling (explosion expansion process), whereupon the softened beads comprising blowing agent foam immediately to give the expanded beads, see by way of example WO 94/20568.

In the extrusion process, the TPU is mixed in an extruder, with melting, with a blowing agent that is introduced into the extruder. In one possibility, the mixture comprising blowing agent is extruded and granulated under conditions of pressure and of temperature such that the granulated TPU material does not foam (expand), and by way of example this can be achieved by using an underwater pelletizer operated at a water pressure of more than 2 bar. This gives expandable beads which comprise blowing agent and which are foamed via heating in a subsequent step to give the expanded beads. In an alternative, it is also possible to extrude and granulate the mixture without using superatmospheric pressure. In this process, the melt strand foams, and the expanded beads are obtained via granulation.

The bulk densities of the expanded TPU foam beads suitable for producing the stall floorcoverings of the invention comprising a foam mat are preferably in the range from 10 kg/m³ to 300 kg/m³, preferably from 25 kg/m³ to 200 kg/m³, particularly preferably from 50 to 150 kg/m³.

The expanded TPU beads are generally at least approximately spherical, and usually have a diameter of from 0.2 to 50 mm, preferably from 0.5 to 20 mm, and in particular from 1 to 15 mm. In the case of non-spherical, e.g. ellipsoidal, elongate or cylindrical, beads diameter means the longest dimension.

The expanded TPU beads can be used in the process that is in principle known to the person skilled in the art to produce expanded TPU-bead foams; (for the purposes of the present invention the expression “expanded TPU-bead foam” describes a foam molding obtainable via adhesive bonding and/or fusion of individual foamed TPU beads). By way of example, the expanded TPU beads can be adhesive-bonded to one another with the aid of an adhesive in continuous or batch processes, for example by using the polyurethane adhesives known to the person skilled in the art. The expanded TPU beads can preferably be fused to one another with exposure to heat in continuous or batch processes, where it is also possible in principle to add adhesives during fusion. However, the expanded TPU beads are particularly preferably fused to one another with exposure to heat by means of hot air or in particular steam to form the expanded TPU-bead foams; in one particularly preferred embodiment the expanded TPU beads are fused by means of hot air or in particular steam without the use of adhesives.

The expanded TPU beads can be used in one of the very particularly preferred processes to produce expanded TPU-bead foams by fusing the E-TPU-beads with exposure to heat in a closed mold, in particular in a molding machine, for example as described in DE-A 25 42 452. For this, the beads are charged to a mold and, after the mold has been closed, hot air, or preferably steam, is introduced, and the beads therefore undergo further expansion and, at temperatures that are preferably between 100° C. and 140° C., are fused to one another to give the expanded TPU-bead foam. The expanded TPU-bead foams particularly preferably take the form of a foam mat, and in this form are in principle suitable for the use as stall floorcovering even without any further processing step.

The thickness of the foam mats that are suitable for use as/production of stall floorcoverings and that comprise expanded TPU-bead foam depends on the specific use of these and is generally in the range from 20 to 150 mm, for cattle mattresses preferably in the range from 30 to 120 mm.

The density of the expanded TPU-bead foams which are produced from the E-TPU beads and which in particular take the form of the foam mats described is preferably in the range from 35 to 300 kg/m³ and in particular from 90 to 250 kg/m³. The density of the expanded TPU-bead foams can by way of example be adjusted via selection of the bulk density of the E-TPU beads and the compaction ratio in the automatic molding machine or in a press. The compaction ratio (molding density/bulk density) is generally in the range from 1.5 to 3.

A foam mat preferred in the invention, in particular for the use as cattle mattress, comprising E-TPU-bead foam exhibits an indentation depth of 20 mm or more under the test conditions of the Deutsche Landwirtschafts-Gesellschaft e.V. (DLG) in relation to softness (i.e. in the ball-impression test in the unused condition, using a head of radius r=120 mm and a penetration force of 2000 N). In relation to long-term underfoot loading (long-term underfoot loading in a test rig using a round steel foot of diameter 105 mm and with an impression area of 75 cm², with, at the periphery of the sole, a ring of width 5 mm extending 1 mm above the remainder of the area, and using 100 000 load cycles at 10 000 N) a preferred foam mat, in particular for the use as cattle mattress, exhibits no significant wear and at most 50%, preferably at most 30%, particularly preferably at most 10%, residual deformation, based on the thickness of the foam mat in the unused condition.

The foam mats that can be produced as described, comprising E-TPU-bead foam, are suitable for use as or producing stall floorcoverings, in particular cattle mattresses.

The foam mats comprising expanded TPU-bead foam have low weight and can easily be subjected to mechanical operations via sawing, milling, or punching. Individual mats can therefore be laid and/or connected to one another relatively easily via a very wide variety of techniques, e.g. via tongue-and-groove connections or dovetail connections.

In order to achieve a further increase in abrasion resistance and slip resistance, the foam mat comprising expanded TPU-bead foam can be provided, on one or both sides, with an outer layer, in particular made of rubber (vulcanized natural or synthetic rubber), polyethylene, polypropylene, polyvinyl chloride, or polyester, with a thickness in the range from 0.5 to 5 mm. The presence of an outer layer on one or both sides of the foam mat is preferred when the expanded TPU-bead foam is formed solely from expanded TPU beads adhesive-bonded to one another rather than from expanded TPU beads fused to one another, since in this embodiment of the adhesive-bonded expanded TPU-bead foam the outer layer provides a marked reduction of wear during long-term use.

The E-TPU foam beads are predominantly, preferably to an extent of more than 95%, closed-cell beads. It is therefore possible, via suitable processing, to produce foam mats with a low proportion of interstices and with an E-TPU-bead foam layer that is impermeable to water. For stall floorcoverings comprising E-TPU-bead foam mats for which permeability to liquid is desirable, drilling or punching processes can easily be used to provide the foam mats (with or without outer layer) with appropriate drainage channels.

The stall floorcovering of the invention can be produced simply and inexpensively, is lightweight and easy to lay, and in comparison with known stall floorcoverings exhibits an improved combination of appropriate softness (corresponding to substantial, but not excessively high penetration depth), low residual deformation during long-term use, low wear during long-term use, and low moisture absorption.

The invention is illustrated in detail by the examples which follow.

### EXAMPLES

### Test Methods

Compressive Strength and Compressive Strain (as a Measure of Softness and Indentation Depth in Freshly Produced Condition and after Long-Term Use):

The newly produced mats or standard test specimens produced therefrom described below were used for determination of compressive strength [kPa] at 75% compressive strain (on standard test specimens, advance velocity 100 mm/min), and also of compressive strain [%] with a constant force of 250 kPa (area loading on mats measuring 18 cm×18 cm, advance velocity 50 mm/min) by a method based on EN ISO 844 of June 2009 (German-language version).

The same mats were also used for determination of compressive strain [%], measured with a constant force of 250 kPa (area loading on mats measuring 18 cm×18 cm) and with an advance velocity of 50 mm/min by a method based on EN ISO 844 of June 2009 (German-language version).

These measures of softness/indentation depth before and after long-term use can also provide estimates of the suitability of a mat as stall floorcovering as a function of the weight of the livestock. Excessive weight on an excessively soft mat leads to excessive indentation depth and thus to a reduced comfort level of animals lying thereon.

Fatigue Test “FT” (as a Measure of Residual Deformation after Long-Term Use);

The newly produced mats described below were subjected to a fatigue test between flat parallel plates. Test specimens measuring 18 cm×18 cm (324 cm²) were subjected here to 40 000 load cycles (dynamic loading) in the pressure range from 0.05 N (preload) to 8.1 kN, corresponding to a maximum area loading of 250 kPa, at a frequency of 0.5 Hz, and the residual height of the mats was then determined as % value based on the initial height before the dynamic loading. The fatigue test simulates long-term use by animals walking on and lying on the mats.

Wear During Long-Term Underfoot Loading:

Wear during long-term underfoot loading on newly produced mats described below was measured on a test rig using a round steel foot with an impression area of 75 cm² and with, at the periphery of the steel foot sole, a ring of width 5 mm extending 1 mm above the remainder of the area of the steel foot. After 100 000 load cycles at 10 000 N the mats were evaluated visually for wear according to the following scale.

-- substantial wear

- moderate wear

o little wear

+ almost no wear

++ no wear

Abrasion Test (as a Measure of Wear During Long-Term Use):

The abrasion resistance of the newly produced mats described below was measured by using a ram with circular contact area (61.5 cm²). The contact area was composed of emery cloth (280 grade). Each two-stroke cycle used a contact force of 500 N in a 180° clockwise and anticlockwise rotation. After 10 000 two-stroke cycles the abrasion depth [mm] was measured and then evaluated in accordance with the following grades:

-- substantial abrasion

- moderate abrasion

o little abrasion

+ almost no abrasion

++ no abrasion

In the case of mats with outer layer, testing was carried out on the outer-layer surface. In the case of mats without outer layer, testing was carried out directly on the mat surface (i.e. the foam surface or rubber surface).

Absorption of Liquid and Permeability to Liquid;

Absorption of liquid [% by weight] was determined by a method based on DIN ISO 2896 via submersion of cubic test specimens with edge length 50 mm in water (23° C.) for one week; (the value stated is the weight increase in % after immersion in water, based on the initial weight of the test specimen before immersion in water).

Production of Mats for Use as Stall Floorcoverings:

For inventive examples 1, 2 and 3 of the starting materials specified in Table 1, a commercially available thermoplastic polyurethane (Elastollan® 1180, Shore A hardness 80) in the form of granulated material was heated in the suspension process with a blowing agent in an autoclave and, without prior cooling, rapidly depressurized to give expanded TPU beads with the bulk densities listed in Table 1. For inventive example 1, the resultant expanded TPU beads were then fused by using steam in a molding machine to give a foam mat with the thickness and molding density stated in Tables 2 and 3. For inventive examples 2 and 3, the foam beads were adhesive-bonded by using a PU prepolymer. In inventive example 2, the adhesive-bonded mat was equipped with an additional PVC outer layer.

For comparative examples CE4 to CE8, conventional processes were used to produce foam mats/rubber mats for use as stall floorcoverings from the other starting materials likewise specified in Table 1.

The expanded polyethylene beads fused to one another in CE7 correspond to a material described as preferred for the foam layer S1 in EP 1 917 852 A1, which has been discussed in the introduction.

The test methods described above were used to test the properties of the resultant mats. The results are shown in table 2,

TABLE 1

| | | Bulk density | |
|---|---|---|---|
| | | of foam | |
| | | beads | Foam |
| Example* | Starting material | [kg/m³] | morphology |
| 1 | Foam mat made of E-TPU beads | 90 | closed-cell |
| | fused by using steam | | |
| 2 | Foam mat made of E-TPU beads | 90 | closed-cell |
| | adhesive-bonded with PU | | |
| | prepolymer + PVC outer layer | | |
| 3 | Foam mat made of E-TPU beads | 70 | closed-cell |
| | adhesive-bonded with PU | | |
| | prepolymer | | |
| CE4 | Foam mat made of flexible PUR | n.a.* | open-cell |
| | foam | | |
| CE5 | Foam mat made of viscoelastic | n.a. | open-cell |
| | PUR foam | | |
| CE6 | Foam mat made of bonded-flake | n.a. | open-cell |
| | foam | | |
| CE7 | Foam mat made of fused | n.t.* | closed-cell |
| | expanded polyethylene particles | | |
| | (EPE) | | |
| CE8 | Mat made of solid rubber | n.a. | compact |

*prefix “CE” means non-inventive comparative example; “n.a.” means not applicable, “n.t.” means not tested.

TABLE 2

| | | Thickness | | Compressive | | Fatigue test | Wear during | | |
|---|---|---|---|---|---|---|---|---|---|
| | Density of | of | Compressive | stain [%] | | (FT) | long-term | | Absorption |
| | mat | mat | strength | before | after | Residual | underfoot | | of liquid [% |
| Example* | [kg/m³] | [mm] | [kPa] | FT | FT | height [%] | loading | Abrasion | by weight] |
| 1 | 250 | 40 | 1790 | 40.2 | 43.1 | 88.1 | ++ | ++ | <10 |
| 2** | 100/103*** | 40/42**** | n.t.* | n.t. | n.t. | n.t. | + | ∘ | <10 |
| 3 | 100 | 40 | n.t. | n.t. | n.t. | n.t. | ++ | −− | <10 |
| CE4 | 120 | 40 | 83 | 86.0 | 86.5 | 84.1 | n.t. | −− | 440 |
| CE5 | 75 | 40 | 20 | 92.5 | 92.9 | 35.3 | n.t. | −− | 580 |
| CE6 | 275 | 40 | 975 | 60.9 | 64.3 | 84.6 | n.t. | − | 300 |
| CE7 | 60 | 40 | 510 | 63.3 | 82.6 | 21.8 | n.t. | − | 54 |
| CE8 | 1170 | 40 | 43 000 | 16.6 | 19.1 | 93.8 | n.t. | + | <10 |

*prefix “CE” means non-inventive comparative example; “n.t.” means not tested,
**mat made of E-TPU-bead foam with PVC outer layer
***density of mat without/with outer layer
****thickness without/with outer layer

Only the inventive examples 1 and 2 comply completely with all of the requirements relating to softness, resistance to long-term use (low residual deformation and low wear); abrasion resistance and little absorption of liquid.

In the case of a mat made of E-TPU-bead foam and produced via adhesive bonding of E-TPU beads (inventive example 3), it is advisable to use an additional outer layer for full compliance with the requirements placed upon abrasion resistance. Damage that can occur to the outer layer in practice during long-term use does not lead to the disadvantages of increased absorption of fecal matter, because the moisture absorption of the E-TPU-bead foam is very low.

Although the mats in comparative examples CE4 to CE7 have very high softness, this softness (low compressive strength) is however so great that the expected loading by heavy livestock causes excessive flattening of the mat, and the comfort level of animals lying thereon is unacceptably reduced. Nor can the density/compressive strength of a flexible PUR foam be increased without restriction in order to solve the problem of excessive softness. Moreover, when flexible PUR foam is used as core material, because this has open cells and therefore absorbs substantial quantities of liquid, it is essential to use an outer layer enclosing all sides of the core.

By using a bonded-flake foam as in CE6 it is possible to adjust compressive strength appropriately, but use without outer layer is impossible because of high abrasion. Even with outer layer, however, this material is disadvantageous because it can absorb large quantities of liquid, and if, as is always possible during long-term use, damage occurs to the outer layer. This leads to absorption of fecal matter.

Although use of a closed-cell polyolefin foam as in CE7 reduces moisture absorption, residual deformation in the fatigue test, and also abrasion, are markedly higher.

When rubber (vulcanized natural or synthetic rubber) is used as mat material as in CE8, the softness that can be achieved is far from the desired softness.

The inventive examples show that the stall floorcoverings of the invention exhibit, when compared with the coverings known from the prior art, an improved combination of appropriate softness (corresponding to substantial, but not excessive, indentation depth), low residual deformation during long-term use, low wear/abrasion during long-term use, and low moisture absorption values. The stall floorcoverings of the invention are light and easy to lay. The stall floorcoverings of the invention are moreover obtainable via production processes which are simple and therefore not expensive.

1. A stall floorcovering comprising a foam mat comprising expanded thermoplastic polyurethane-bead foam.

2. The stall floorcovering according to claim 1, wherein the thermoplastic polyurethane-bead foam has a Shore hardness in the range from 50 Shore A to 75 Shore D, measured in accordance with DIN ISO 7619-1 DE on test specimens made of non-expanded thermoplastic polyurethane of thickness 6 mm.

3-10. (canceled)

11. The stall floorcovering according to claim 1, wherein the foam mat has a density in the range from 35 to 300 kg/m³.

12. The stall floorcovering according to claim 1, wherein the foam mat has a thickness in the range from 20 to 150 mm.

13. The stall floorcovering according to claim 2, wherein the foam mat has a density in the range from 35 to 300 kg/m³, and a thickness in the range from 20 to 150 mm.

14. The stall floorcovering according to claim 1, wherein the foam mat includes an outer layer comprising a polymer selected from rubber, polyethylene, polypropylene, polyvinyl chloride, or polyester, the outer layer with a thickness in the range from 0.5 to 5 mm.

15. The stall floorcovering according to claim 13, wherein the foam mat includes an outer layer comprising a polymer selected from rubber, polyethylene, polypropylene, polyvinyl chloride, or polyester, the outer layer with a thickness in the range from 0.5 to 5 mm.

16. The stall floorcovering according to claim 1, wherein the thermoplastic polyurethane from which the polyurethane-bead foam is formed has a melt flow rate at 190° C. less than 200 g/10 min with an applied weight of 21.6 kg in accordance with DIN EN ISO 1133

17. The stall floorcovering according to claim 1, wherein the expanded thermoplastic polyurethane-bead foam is approximately spherical with a diameter form 0.5 mm to 20 mm.

18. The stall floorcovering according to claim 1, wherein the expanded thermoplastic polyurethane-bead foam is formed from expanded thermoplastic polyurethane beads that are thermally-fused to one another following exposure to heat.

19. The stall floorcovering according to claim 1, wherein the expanded thermoplastic polyurethane-bead foam is formed from expanded thermoplastic polyurethane beads bonded to one another with an adhesive.

20. A process for producing a stall floorcovering according to claim 18, the process comprising fusing the expanded, thermoplastic foam beads by thermally exposing the polyurethane bead foam to hot air or steam, the expanded thermoplastic polyurethane having a bulk density in a range from 10 to 300 kg/m³.

21. A process for producing a stall floorcovering according to claim 19, the process comprising applying the adhesive to the expanded, thermoplastic foam beads, the expanded thermoplastic polyurethane having a bulk density in a range from 10 to 300 kg/m³.
